(19) United States
(12) Patent Application Publication
(10) Pub. No.: US 2026/0071050 A1
(43) Pub. Date: Mar. 12, 2026

(54) BIODEGRADABLE POLYMER COMPOSITIONS

(71) Applicant: Interfacial Consultants LLC, Prescott, WI (US)

(72) Inventors: Jeffrey J. Cernohous, Hudson, WI (US); Nathan Ockwig, Eagan, MN (US)

(21) Appl. No.: 18/706,100

(22) PCT Filed: Nov. 1, 2022
(86) PCT No.: PCT/US2022/048563

§ 371 Date: Apr. 30, 2024

Related U.S. Application Data
(60) Provisional application No. 63/274,067, filed on Nov. 1, 2021.

(51) Int. Cl. C08K 5/1545; B29C 35/02; B29K 67/00; C08K 5/053

(52) U.S. Cl. CPC C08K 5/1545; B29C 35/02; C08K 5/053; B29C 2035/0283; B29K 2067/046; B29K 2995/0012; B29K 2995/006; B29K 2995/0082; B29K 2995/0089

(57) ABSTRACT

A biodegradable polymer composition comprising a biodegradable polymer and a thermally stable sugar. The biodegradable polymer composition has markedly improved mechanical, thermal and biodegradation properties when compared to the biodegradable polymer itself.

### CROSS-REFERENCE TO RELATED APPLICATION

This application claims priority to U.S. Provisional Application No. 63/274,067 filed Nov. 1, 2021, which is hereby incorporated by reference.

### TECHNICAL FIELD

This disclosure relates to compositions and methods for making and using a biodegradable polymer composition.

### BACKGROUND

Biodegradable polymers have application in several commercial markets including those that do not require the materials to be durable, like the packaging and additive manufacturing/3D printing market. Ideally, it is desirable for the material in these applications to function for short term use, but then rapidly degrade upon disposal. The biodegradation of the polymer helps to address environmental concerns of single use plastic articles. However, application has been limited to date because the biodegradable polymers fail to meet certain physical and chemical characteristics that are required to function for commercial use. For example, if a biodegradable polymer is formed into an eating utensil, it ideally will stand up to temperatures of hot food or drinks which may be as high as the boiling point of water, 100° C. Unfortunately, bioplastics commonly used in the market including polylactic acid (PLA) and polyhydroxy alkanoates (PHA) deform at temperatures much lower than this (between 5° and 70° C.) and as a result, these materials have found limited commercial application relative to hydrocarbon based thermoplastic materials (e.g., polyethylene, polypropylene and polystyrene). Another disadvantage of commercially available biodegradable polymers is that they can have very slow crystallization kinetics. This negatively impacts the melt processing and forming of such materials using conventional melt processing techniques like extrusion, injection molding, and thermoforming. PLA is specifically slow to crystallize. Cycle times for melt processing and forming PLA can be more than 2-3 times longer than conventional thermoplastic materials. Finally, certain biodegradable polymers are not readily biodegradable under a wide range of situations, but rather may require a particular set of environmental conditions. For example, PLA is only readily biodegradable under the specific conditions offered by industrially composting techniques. It would be desirable to improve biodegradation of such materials. The biodegradable compositions of this disclosure address all of these key issues associated with commercially available biodegradable polymers. In one embodiment, we have found that melt processing a biodegradable polymer with a thermally stable sugar produces compositions that have improved thermal, mechanical and biodegradation properties. The compositions of this disclosure have utility in many applications including packaging, consumer goods, 3D printed articles and prototypes.

### SUMMARY

Biodegradable polymer compositions, including a biodegradable polymer (e.g., polyhydroxyalkanoate (PHA)) and a thermally stable sugar (e.g., Trehalose) have been found to address many of the issues of commercially available biodegradable polymers. Specifically, biodegradable compositions of this disclosure have been found to have markedly improved thermal resistance, faster crystallization kinetics, and improved biodegradation.

The biodegradable polymer compositions of this disclosure are melt processable and include a biodegradable polymer and a thermally stable sugar. The sugar component of this composition is thermally stable at temperatures required to melt process the biodegradable polymer using conventional melt processing techniques (e.g., extrusion, injection molding and thermoforming).

In some embodiments, biodegradable polymer compositions have improved thermal resistance, or modulus at use temperature. This property can be determined by measuring the heat distortion or deflection at elevated temperatures following methods such as ASTM D648-Standard Test Method for Deflection Temperature of Plastics Under Flexural Load in the Edgewise Position. In one embodiment, the biodegradable polymer compositions of this disclosure have heat deflection temperatures above 80° C., in other embodiments, above 100° C.

In some embodiments, biodegradable polymer compositions have improved crystallization kinetics as determined by differential scanning calorimetry (DSC). This property can be determined by measuring the enthalpies of fusion, and associated thermal transition phenomena through ASTM D3418-Standard Test Method for Transition Temperatures and Enthalpies of Fusion and Crystallization of Polymers by Differential Scanning calorimetry. In one embodiment, the biodegradable polymer compositions of this disclosure have a crystallization enthalpy equal to more than two times the crystallization enthalpy of the biodegradable polymer of the composition. In another embodiment, the biodegradable polymer compositions of this disclosure have a crystallization enthalpy equal to more than three times the crystallization enthalpy of the biodegradable polymer of the composition

In some embodiments, biodegradable polymer compositions have improved biodegradation rates as determined by exposing articles of the biodegradable polymer composition to bacteria in a laboratory controlled biodegradation experiment, for example as determined by bulk biodegradation of molded parts. In one embodiment, the biodegradable polymer compositions of this disclosure have a biodegradation rate at least to two times higher than that of the of the biodegradable polymer of the composition. In another embodiment, the biodegradable polymer compositions of this disclosure have biodegradation rate at least three times the greater than that of the biodegradable polymer of the composition.

In some embodiments, a biodegradable polymer composition is created by melt processing a biodegradable polymer and a thermally stable sugar. The composition of this disclosure can be produced using a variety of melt processing techniques, including extrusion. One melt processing technique to create the biodegradable polymer composition is twin screw extrusion. The biodegradable polymer composition can be further formed into various articles using additional melt processing techniques like injection molding, thermoforming, profile extrusion, and 3D printing.

In some embodiments, the biodegradable polymer composition of this disclosure is melt processed into a three dimensional printing feedstock. For example, the biodegradable polymer composition can be extruded into a filament that can be used in a fused deposition modeling (FDM) or fused filament fabrication (FFF) type three dimensional printer. A three-dimensional printed article of the biodegradable polymer composition can be subsequently formed using this feedstock. A three-dimensional printing process includes a three-dimensional printed object generally dispensed on a substantially horizontal build plate in a build chamber.

The above summary is not intended to describe each disclosed embodiment or every implementation. The detailed description that follows more particularly exemplifies illustrative embodiments.

### BRIEF DESCRIPTION OF THE DRAWINGS

FIG. 1 is a scanning electron microscope image at magnification of 600× of Comparative Example 3 after exposure to bulk biodegradation testing of molded parts for 7 days.

FIG. 2 is a scanning electron microscope image at magnification 600×, of the surface of example #9 after exposure to bulk biodegradation testing of molded parts for 7 days.

FIG. 3 is a scanning electron microscope image at magnification of 600×, of Comparative Example #11 after exposure to bulk biodegradation testing of molded parts for 7 days.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus, for example, a biodegradable polymer composition including “a” biodegradable polymer means that the biodegradable polymer composition may include “one or more” biodegradable polymers.

The terms “additive manufacturing,” “three-dimensional printing,” “3D printing,” or “3D printed” refer to any process used to create a three-dimensional object in which successive layers of material are formed under computer control (e.g., electron beam melting (EBM), fused deposition modeling (FDM), ink jetting, laminated object manufacturing (LOM), selective laser sintering (SLS), and stereolithography (SLA)).

The term “biodegradable polymer” means a polymer that can be degraded, and/or consumed by biota (bacteria, fungi, and actinomycetes) into lower molecular weight subunits.

The term “biodegradable polymer composition” refers to a composition comprising a biodegradable polymer and a thermally stable sugar.

The term “build chamber” refers to a volume, often enclosed, in or utilized by an additive manufacturing device within which a desired object can be printed. A non-limiting example of build chamber can be found in an ARBURG™ Freeformer (commercially available from Arburg GmbH, Lossburg, Germany).

The term “build chamber temperature” refers to the temperature provided in a build chamber during additive manufacturing.

The term “build material” refers to a material that is printed in three dimensions using an additive manufacturing process to produce a desired object, often remaining after removal of a soluble support.

The term “build plate” refers to a substrate, often a removable film or sheet, that a build material or soluble support can be printed on.

The term “composition” refers to a multicomponent material.

The term “copolymer” refers to a polymer derived, actually (e.g., by copolymerization) or conceptually, from more than one species of monomer. A copolymer obtained from two monomer species is sometimes called a bipolymer; a copolymer obtained from three monomers is sometimes called a terpolymer; a copolymer obtained from four monomers is sometimes called a quaterpolymer; etc. A copolymer can be characterized based on the arrangement of branches in the structure, including, e.g., as a linear copolymer and a branch copolymer. A copolymer can also be characterized based on how the monomer units are arranged, including, e.g., as an alternating copolymer, a periodic copolymer, a statistical copolymer, a graft copolymer, and a block copolymer.

The term “biopolymer” is a polymer derived, actually or conceptually, from a biologically produced monomer.

The term “copolymerization” refers to polymerization in which a copolymer is formed.

The term “crystallization enthalpy” refers to the value as measured by differential scanning calorimetry (DSC) in accordance with ASTM standard D3418-Standard Test Method for Transition Temperatures and Enthalpies of Fusion and Crystallization of Polymers by Differential Scanning calorimetry.

The terms “disaccharide,” “double sugar,” or “biose” refer to a sugar compound formed, whether actually or conceptually, by a glycosidic bond between two monosaccharides or monosaccharide residues.

The term “feedstock” refers to the form of a material that can be utilized in an additive manufacturing process (e.g., as a build material or soluble support). Non-limiting feedstock examples include pellets, powders, filaments, billets, liquids, sheets, shaped profiles, etc.

The term “melt processing technique” means a technique for applying thermal and mechanical energy to reshape, blend, mix, or otherwise reform a polymer or composition, such as compounding, extrusion, injection molding, blow molding, rotomolding, or batch mixing. 3D printing processes that are useful in printing thermoplastic and elastomeric melt processable materials are examples of a melt processing technique.

The term “mixing” means to combine or put together to form one single substance, mass, phase, or more homogenous state. This may include, but is not limited to, all physical blending methods, extrusion techniques, or solution methods.

The term “monomer” refers to a molecule that can undergo polymerization to contribute structural units to the essential structure of a polymer.

The term “monosaccharide” refers to a molecule that is a simple sugar and cannot be hydrolyzed to form a simpler sugar. The term includes aldoses, ketoses, and various derivatives, such as sugar alcohols. Such derivatives can be formed, whether actually or conceptually, by oxidation, deoxygenation, introduction of other substituents, alkylation and acylation of hydroxy groups, and chain branching. Non-limiting examples of a monosaccharide include triose, tetrose, pentose, hexose, glyceraldehyde, and dihydroxyacetone.

The term “oligosaccharide” means a small number (e.g., 2 to 6 or 2 to 4) of monosaccharide residues covalently linked.

The terms “polymer” and “polymeric” refer a molecule of high relative molecular mass, the structure of which essentially contains multiple repetitions of units derived, actually or conceptually, from molecules of low relative molecular mass. The term “polymer” can refer to a “copolymer” or “biopolymer”.

The term “polymerization” refers to the process of converting monomers into a polymer.

The term “polysaccharide” refers to compounds consisting of many monosaccharide units, disaccharide units, oligosaccharide units, or residues thereof linked glycosidically (e.g., starch, Pullulan, Chitin, Amylose, Pectin, etc.).

The term “sugar” refers to a compound including carbon, hydrogen, and oxygen, such as an aldose or a ketose that can have, but is not limited to, a stoichiometric formula of Cₙ(H₂O)ₙ. The term can refer to any monosaccharide, disaccharide, oligosaccharide, or polysaccharide as well as a compound derived, whether actually or conceptually, from them by reduction of the carbonyl group (alditols), by oxidation of one or more terminal groups to a carboxylic acid, or by replacement of one or more hydroxy group(s) by a hydrogen atom, an amino group, thiol group, sulfate group, phosphate group, or similar groups. The term can also refer to a derivative, whether actual or conceptual, from such a compound.

The term “thermally stable” refers to a composition that shows little to no degradation as determined by thermogravimetric analysis (TGA) following ASTM E2550-Standard Test method for Thermal Stability by Thermogravimetry.

The recitation of numerical ranges using endpoints includes all numbers subsumed within that range (e.g. 1 to 5 includes 1, 1.5, 3, 3.95, 4.2, 5, etc.).

Biodegradable and/or biobased polymer compositions of this disclosure are produced by melt processing biodegradable polymers with a thermally stable sugar. A variety of biodegradable and/or biobased polymers may be employed in a biodegradable polymer composition. Non-limiting examples of biodegradable polymers include peptides, aliphatic polyesters, polyamino acids, polyamides, polyalkylene glycols and copolymers, and combinations or blends thereof. In one embodiment, the biodegradable polymer is a polyester. Non-limiting examples of linear polyesters include polylactic acids (PLA), poly-L-lactic acid (PLLA), and a random copolymer of L-lactic acid and D-lactic acid (PLDA) and derivatives thereof. Other non-limiting examples of polyesters include polycaprolactone (PCL), polyhydroxybutyrate (PHB), polyhydroxyalkanoate (PHA), polyhydroxyvalerate (PHV), polyethylene succinate (PES), polybutylene succinate (PBS), polybutylene adipate (PBA), polymalic acid (PMLA), polyglycolic acid (PGA), and polydioxanone. Non-limiting examples of specific polyesters useful in this disclosure include Ingeo polylactic acid (commercially supplied by Natureworks, Inc) and Nodax polyhydroxy alkanoate (commercially supplied by Danimer Scientific, Inc).

Depending on the choice of biodegradable polymer, one skilled in the art will recognize that this will impact the selection of the thermally stable sugar. In one embodiment, the sugar of this disclosure is thermally stable to 150° C., in another embodiment, the sugar of this disclosure is thermally stable to 170° C., in yet another embodiment, the sugar of this disclosure is thermally stable to 200° C. It should be mentioned that sugars of this disclosure can be hygroscopic. Loss of mass due to loss of water (dehydration) at elevated temperatures above 100° C. are not indicative that a sugar is not thermally stable. Degradative loss, breakdown of the sugar at temperatures above the boiling point of water, specifically above approximately 120° C. are indicative of thermal breakdown of the sugar molecule. Non-limiting examples of thermally stable sugars of this disclosure include sugars include monosaccharides, disaccharides, oligosaccharides, polysaccharides, sugar alcohols, or derivatives thereof. A non-limiting commercially available example of a sugar is trehalose, sold as TREHA™ sugar by Nagase Corporation (Tokoyo, Japan). Other exemplary sugars include, but are not limited to, sucrose, lactulose, lactose, maltose, cellobiose, chitobiose octaacetate, kojibiose, nigerose octaacetate, isomaltose, isomaltulose, beta,beta-trehalose, alpha,beta-trehalose, sophorose, laminaribiose, gentiobiose, turanose, maltulose, palatinose, gentiobiulose, mannobiose, melibiose, melibiulose, ructinose, ructinulose, melezitose, xylobiose, xylitol, ribitol, mannitol, sorbitol, galactitol, fucitol, iditol, inositol, perseitol, volemitol, isomalt, maltitol, lactitol, maltotriitol, or maltotetraitol.

It may be desirable to employ a sugar in a biodegradable polymer composition that has at least a certain melting point. For example, it may be desirable to employ a sugar having at melting point of at least 85° C., of at least 100° C., of at least 125° C., of at least 140° C., of at least 150° C., of at least 160° C., of at least 175° C., of at least 180° C., of at least 185° C., of at least 186° C., of at least 190° C., of at least 195° C., of at least 196° C., of at least 200° C., of at least 203° C., of at least 210° C., of at least 215° C., of at least 250° C., of at least 253° C., of at least 300° C., or of at least 304° C. Some exemplary sugars and their respective melting points are shown in Table 1.

TABLE 1
SUGAR MELTING POINTS

| | Melting | | Melting |
|---|---|---|---|
| | Point | | Point |
| Material | (° C.) | Material | (° C.) |
| chitobiose | 304-405 | Lactulose | 169 |
| octaacetate | | | |
| Laminaribiose | 253 | Maltose | 160-165 |
| | | (anhydrous) | |
| Inositol | 226 | Meletiose | 152 |
| Cellobiose | 225 | Glyceraldehyde | 145 |
| | | (Triose) | |
| Trehalose | 203 | Turanose | 142 |
| Lactose | 203 | Palatinose | 125-128 |
| Sophorose | 196-198 | Maltulose | 125 |
| Xylobiose | 195 | Isomaltulose | 123 |
| Gentiobiose | 190-195 | Sorbitol | 95 |
| Sucrose | 186 | Xylitol | 92 |
| Kojibiose | 175 | Melibose | 85 |

A variety of additional additives may optionally be employed in a biodegradable polymer composition. Non-limiting examples of suitable additives include antioxidants, light stabilizers, fibers, blowing agents, foaming additives, antiblocking agents, heat reflective materials, heat stabilizers, impact modifiers, biocides, antimicrobial additives, compatibilizers, plasticizers, tackifiers, processing aids, lubricants, coupling agents, thermal conductors, electrical conductors, catalysts, flame retardants, oxygen scavengers, fluorescent tags, inert fillers, minerals, and colorants. Additives may be incorporated into a biodegradable polymer composition as a powder, liquid, pellet, granule, or in any other extrudable form. The amount and type of conventional additives in the biodegradable polymer composition may vary depending upon the polymeric matrix and the desired properties of the finished composition. In view of this disclosure, a person having ordinary skill in the art will recognize that an additive and its amount can be selected in order to achieve desired properties in the finished material or article. Typical additive loading levels may be, for example, approximately 0.01 to 5 wt % of the composition formulation.

A variety of additional polymers may optionally be employed in a biodegradable polymer composition. Such polymers can include virgin or recycled thermoplastics, elastomers, and thermosets. Non-limiting examples of such polymers include high density polyethylene (HDPE), low density polyethylene (LDPE), linear low density polyethylene (LLDPE), polypropylene (PP), polyolefin copolymers (e.g., ethylene-butene, ethylene-octene, ethylene-vinyl acetate, ethylene-vinyl alcohol), polystyrene, polystyrene copolymers (e.g., high impact polystyrene, acrylonitrile-styrene, acrylonitrile-butadiene-styrene), polyacrylates, polymethacrylates, polyesters, polyvinylchloride (PVC), fluoropolymers, liquid crystal polymers, polyamides, polyimides, polyether imides, polyphenylene sulfides, polysulfones, polyacetals, polycarbonates, cycloolefin copolymers, silicones, polyphenylene oxides, polyurethanes, thermoplastic elastomers, thermoplastic vulcanates, epoxies, alkyds, melamines, phenolics, vinyl esters or combinations thereof.

A biodegradable polymer composition will dissolve and/or disintegrate, or some combination thereof, when exposed to bacteria under specific test methods. Non-limiting methods useful in determining the rate of biodegradation of the biodegradable polymer compositions include ASTM D5338-Standard Test Method for Determining Aerobic Biodegradation of Plastic Materials Under Controlled Compositing Conditions, Incorporating Thermophilic Temperatures; ASTM D5538-Standard Method for Determining Aerobic Biodegradation of Plastic Materials Under Controlled Compositing Conditions; ASTM D5511-Standard Test Method for Determining Anaerobic Biodegradation of Plastic Materials Under High-Solids Anaerobic-Digestion Conditions; ASTM D5526-Standard Test Method for Determining Anaerobic Biodegradation of Plastic Materials Under Accelerated Landfill Conditions; ASTM D5988-Standard Test Method for the Determining Anaerobic Biodegradation in Soil of Plastic Materials or Residual Plastic Materials After Composting; ASTM D6002 (withdrawn 2011)-Standard Guide for Assessing the Compostability of Environmentally Degradable Plastics (and test methods contained therein); ASTM D6691-Standard Test Method for Determining Aerobic Biodegradation of Plastic Materials in the Marine Environment by a Defined Microbial Consortium or Natural Sea Water Inoculum; ASTM D7081 (withdrawn 2014)-Standard Specification for Non-floating Biodegradable Plastics in the Marine Environment (and methods contained therein); ASTM D7991-Standard Test Method for Determining Aerobic Biodegradation of Plastics Buried in the Sandy Marine Sediment under Controlled Laboratory Conditions; ASTM D6400-Standard Specification for Labeling of Plastics Designed to be Aerobically Composted in Municipal or Industrial Facilities (and methods contained therein); or the European equivalent of the ASTM standards (ISO 19679; ISO 18830; ISO 14851; ISO 14855; ISO 17088). In one embodiment, the biodegradable polymer composition degrades at least two times faster than the base biodegradable polymer, in another embodiment, it degrades at least three times faster.

A variety of different loadings of biodegradable polymer and thermally stable sugar can be employed in a biodegradable polymer composition. In some embodiments, a biodegradable polymer composition may, for example, include at least about 1 wt % thermally stable sugar, or at least about 10 wt % thermally stable sugar, or at least about 20 wt % thermally stable sugar, or at least about 40 wt % thermally stable sugar, and up to about 50 wt % thermally stable sugar, or up to about 70 wt % thermally stable sugar. In some embodiments, a biodegradable polymer composition may include at least 30% biodegradable polymer, and up to about 50 wt % biodegradable polymer, or up to about 75 wt % biodegradable polymer, or up to about 90 wt % biodegradable polymer, or up to about 95 wt % biodegradable polymer, or up to about 99 wt % biodegradable polymer. In another embodiment, the biodegradable polymer composition contains between 30-99 wt % of a biodegradable polymer. In yet another embodiment, the biodegradable polymer composition contains between 40-90 wt % of a biodegradable polymer.

A biodegradable polymer composition can be prepared by heating, solid mixing, solution mixing, melt processing, or a combination thereof. Depending on the selected polymeric matrix, this can be done using a variety of mixing processes known to those skilled in the art in view of this disclosure. The biodegradable polymer, thermally stable sugar, and any additional additives or polymers can be combined (e.g. by a compounding mill, a Banbury mixer, or a mixing extruder). In another embodiment, a vented twin screw extruder is utilized. The materials may be used in the form of, for example, a powder, a pellet, or a granular product. The mixing operation is most conveniently carried out at temperatures at or above the melt processing temperatures of the biodegradable polymer, the thermally stable sugar, or both. The resulting melt processed biodegradable polymer composition can be extruded directly into the form of the final product shape, or can be pelletized or fed from the melt processing equipment into a secondary operation to pelletize the composition (e.g., using a pellet mill or densifier) for later use. In another embodiment, the biodegradable polymer composition and any optional additives or polymers can be 3D printed.

A biodegradable polymer composition can provide a number of advantages. In some embodiments, biodegradable polymer compositions have improved thermal resistance, or modulus at use temperature. This property can be determined by measuring the heat distortion or deflection at elevated temperatures according to methods, such as ASTM D648-Standard Test Method for Deflection Temperature of Plastics Under Flexural Load in the Edgewise position. In one embodiment, the biodegradable polymer compositions of this disclosure have heat deflection temperatures above 80° C., in other embodiments, above 100° C. In some embodiments, biodegradable polymer compositions have improved crystallization kinetics as determined by differential scanning calorimetry (DSC). In one embodiment, the biodegradable polymer compositions of this disclosure have a crystallization enthalpy equal to more than two times the crystallization enthalpy of the biodegradable polymer of the composition. In another embodiment, the biodegradable polymer compositions of this disclosure have a crystallization enthalpy equal to more than three times the crystallization enthalpy of the biodegradable polymer of the composition. In some embodiments, biodegradable polymer compositions have improved biodegradation rates as determined by exposing articles of the biodegradable polymer composition to bacteria in a controlled biodegradation experiment, for example as determined by bulk biodegradation testing of molded parts. In one embodiment, the biodegradable polymer compositions of this disclosure have a biodegradation rate at least to two times higher than that of the biodegradable polymer of the composition. In another embodiment, the biodegradable polymer compositions of this disclosure have biodegradation rate at least three times the greater than that of the biodegradable polymer of the composition.

A biodegradable polymer composition can undergo additional processing for desired end-use applications. A biodegradable polymer composition can be used as a feedstock in fused deposition modeling (FDM). In some embodiments, the feedstock may be a filament but other feedstocks (e.g., film, sheet, shaped profile, powder, pellet, etc.) can also be used. For an FDM feedstock, it is desirable to have a proper balance of stiffness and toughness. The need for this is two-fold; first, filament production considerations, and second, the material must function properly when processed using an FDM based 3D printer. If the material is too soft, it has a tendency to flex, buckle, or stretch when the drive system tries to push or pull the filament into or out of the filament extruder head or liquifier. If the filament is not tough enough, it has a tendency to break when unwinding and/or traveling through the path to the filament extruder head or liquifier. Those skilled in the art will recognize that an FDM filament composition should be designed to have the proper balance of stiffness and toughness in order to function with a FDM type printer.

A biodegradable polymer composition can also be converted into an article using conventional melt processing techniques, such as compounding, extrusion, molding, and casting, or additive manufacturing processes. For use in additive manufacturing processes, a variety of additive manufacturing devices can employ water soluble polymer compositions, as, for example, a support or build material. Non-limiting examples of such additive manufacturing devices include, but are not limited to, the Dremel DigiLab 3D45 3D Printer, LulzBot Mini 3D Printer, MakerBot Replicator+, XYZprinting da Vinci Mini, Ultimaker 3, Flashforge Finder 3D Printer, Robo 3D R1+Plus, Ultimaker 2+, Ultimaker 5s, and AON M2. A water soluble polymer composition can be selectively removed as either a build or support material (e.g., by dissolution or mechanically) manually, automatically (e.g., computer controlled dissolution), or by some combination thereof. A variety of polymers and additives, such as those already disclosed above, can be added to the biodegradable polymer composition to form an article.

Biodegradable polymer compositions and articles including such compositions have broad utility in a number of industries, including, but not limited to, packaging, consumer goods and additive manufacturing. These compositions and articles can provide significant value to plastics compounders and converters. The disclosed compositions and articles offer enhanced adhesion to hydrophobic polymers, tunable rheological properties, increased stiffness, improved crystallization kinetics, improved heat resistance and enhanced biodegradation profiles.

In the following examples, all parts and percentages are by weight unless otherwise indicated.

### Examples

TABLE 2
MATERIALS

| Material | Supplier |
|---|---|
| Biodegradable | “Ingeo 2003D” polylactic acid, |
| Polymer 1 (BP1) | commercially available from Natureworks, |
| | Inc. (Minneapolis, MN) |
| Biodegradable | “Ingeo 4043D” polylactic acid, |
| Polymer 2 (BP2) | commercially available from Natureworks, |
| | Inc. (Minneapolis, MN) |
| Biodegradable | Nodax, polyhydroxy alkanoate (PHA), |
| Polymer 3 (BP3) | commercially available from Danimer |
| | Scientific (Winchester, KY) |
| Sugar 1 (S1) | Trehalose, commercially available from |
| | Hayashibara, Inc (Okayama, Japan) |
| Sugar 2 (S2) | Inositol, commercially available from |
| | Prinova, Inc (Hanover Park, IL) |

TABLE 3
EXPERIMENTAL FORMULATIONS

| Example | BP 1 | BP 2 | BP 3 | S1 | S2 |
|---|---|---|---|---|---|
| CE1 | 100 | | | | |
| CE2 | | 100 | | | |
| CE3 | | | 100 | | |
| 1 | 90 | | | 10 | |
| 2 | 80 | | | 20 | |
| 3 | 70 | | | 30 | |
| 4 | 60 | | | 40 | |
| 5 | 50 | | | 50 | |
| 6 | | | 90 | 10 | |
| 7 | | | 80 | 20 | |
| 8 | | | 70 | 30 | |
| 9 | | | 65 | 35 | |
| 10 | | | 60 | 40 | |
| 11 | | | 50 | 50 | |
| 12 | | 90 | | 10 | |
| 13 | | 80 | | 20 | |
| 14 | | 70 | | 30 | |
| 15 | 90 | | | | 10 |
| 16 | 80 | | | | 20 |
| 17 | 70 | | | | 30 |
| 18 | | | 70 | | 30 |

### Sample Preparation: Formulations CE1-3, 1-18

Each of Formulations 1-18 was prepared according to the weight ratios in Table 3. Formulations 1-18 were fed into a 27 mm twin screw extruder (40:1 L:D, commercially available from Leistritz Extrusiontechnik GmbH, Germany). Biodegradable polymer fed into the throat at zone 1, and the sugar was side fed at zone 6. Compounding for formulations 1-18 was performed using the following temperature profile in zones 1-10:180 degrees Celsius, and a die temperature of 170 degrees Celsius. The extruder's screw speed was about 250 rpm, and the output rate was about 25 kg/hr. The mixture was then extruded onto an air cooled belt conveyor, pelletized into approximately 2.5 mm×2.5 mm cylindrical pellets, and collected in a plastic bag. Samples CE1-3 and 1-18 were subsequently injection molded using an 40 ton Arburg All-Rounder injection molder into an mold having an ASTM tensile and flexural specimens. Barrel temperatures were 180 degrees Celsius, injection pressure of 18,000 pounds per square inch, and a mold temperature of 50 degrees Celsius.

### Flexural, Impact and Heat Deflection Characterization: Formulations CE1-3, 1-18

Formulations CE1-3 and 1-18 were characterized for flexural properties following ASTM D790-Standard Test Method for Flexural Properties of Unreinforced and Reinforced Plastics and Electrical Insulating Materials, impact properties following ASTM D256-Standard Test Methods for Determining the Izod Pendulum Impact Resistance of Plastics and ASTM D4812-Standard Test Method for Unnotched Cantilever Beam Impact Resistance of Plastics, heat deflection temperature following ASTM D648-Standard Test Method for Deflection Temperature Under Flexural Load in the Edgewise Position. The results of this testing are provided in Table 4.

TABLE 4
FLEXURAL, IMPACT and HEAT DEFLECTION TESTING
RESULTS FORMULATIONS CE1-3 and 1-18

| | | | | | Heat |
|---|---|---|---|---|---|
| | | | | | Deflection |
| | | | Notched | Unnotched | Temper- |
| | Flexural | Flexural | Izod | Izod | ature @ |
| | Strength | Modulus | Impact | Impact | 0.45 MPa |
| Formulation | (Kpsi) | (Kpsi) | (ft-lbs/in) | (ft-lbs/in) | (° C.) |
| CE1 | 16.9 | 540 | 0.53 | 4.0 | 54 |
| CE2 | 15.4 | 475 | 0.50 | 4.0 | 52 |
| CE3 | 10.0 | 380 | 0.42 | 2.5 | 80 |
| 1 | 15.5 | 540 | 0.67 | 3.0 | 55 |
| 2 | 15.0 | 578 | 0.57 | 2.7 | 59 |
| 3 | 13.8 | 700 | 0.50 | 2.8 | 56 |
| 4 | 11.9 | 827 | 0.41 | 1.8 | 67 |
| 5 | 10.0 | 954 | 0.33 | 1.3 | 87 |
| 6 | 9.0 | 488 | 0.36 | 2.7 | 99 |
| 7 | 7.7 | 522 | 0.30 | 2.2 | 111 |
| 8 | 6.9 | 591 | 0.26 | 1.5 | 117 |
| 9 | 6.4 | 615 | 0.26 | 1.3 | 108 |
| 10 | 6.4 | 686 | 0.23 | 1.1 | 100 |
| 11 | 5.6 | 805 | 0.23 | 0.8 | 97 |
| 12 | 15.5 | 546 | 0.58 | 2.7 | 57 |
| 13 | 14.8 | 606 | 0.56 | 2.4 | 55 |
| 14 | 13.5 | 656 | 0.53 | 1.7 | 61 |
| 15 | 14.7 | 572 | 0.59 | 3.8 | 55 |
| 16 | 14.0 | 685 | 0.60 | 3.0 | 56 |
| 17 | 12.6 | 806 | 0.91 | 2.1 | 55 |
| 18 | 6.3 | 569 | 0.28 | 1.5 | 98 |

### DSC/TGA Characterization

A differential scanning calorimetry (DSC) and thermal gravimetric analysis study was performed on Formulations CE 1-3 and 1-18. To determine glass and decomposition temperatures, all samples were heated from room temperature to 300° C. at a ramp rate of 10° C./min under an air atmosphere with a nitrogen carrier gas. To determine crystallization enthalpy, all samples were heated to 200° C. at a ramp rate of 10° C./min, following by a cooling cycle at 10° C./min. Table 5 shows results of this characterization, specifically key DSC glass and melting transitions temperatures (Tg and Tm), as well as decomposition temperatures.

TABLE 5
DSC ON FORMULATIONS CE1-3 AND 1-18

| | | Crystal- | | Decom- |
|---|---|---|---|---|
| | Melting | lization | Crystal- | position |
| | Temper- | Temper- | lization | Temper- |
| | ature(s) | ature | Enthalpy | ature |
| Formulation | (° C.) | (° C.) | (J/g) | (° C.) |
| CE1 | 151 | n/a | n/a | 330 |
| CE2 | 150, 163, 175 | 77 | 37.6 | |
| CE3 | 148 | 85 | 41.4 | 286 |
| 1 | 151 | n/a | n/a | 270 |
| 2 | 151 | n/a | n/a | 264 |
| 3 | 152 | n/a | n/a | 259 |
| 4 | 152 | n/a | n/a | 257 |
| 5 | 151 | n/a | n/a | 258 |
| 6 | 147, 161, 171, 211 | 82 | 39.0 | 270 |
| 7 | 147, 161, 171, 213 | 83 | 33.5 | 268 |
| 8 | 148, 162, 171, 214 | 81 | 24.2 | 272 |
| 9 | 150, 165, 174, 211 | 74 | 22.8 | 278 |
| 10 | 150, 165, 174, 212 | 72 | 18.4 | 277 |
| 11 | 150, 166, 175, 213 | 69 | 14.5 | 276 |
| 12 | 154, 161 | n/a | n/a | 260 |
| 13 | 150 | n/a | n/a | 258 |
| 14 | 149 | n/a | n/a | 255 |
| 15 | 155, 228 | n/a | n/a | 317 |
| 16 | 155, 230 | n/a | n/a | 318 |
| 17 | 155, 233 | n/a | n/a | 320 |
| 18 | 149, 163, 173, 230 | 76 | 25.1 | 286 |

### Biodegredation Characterization

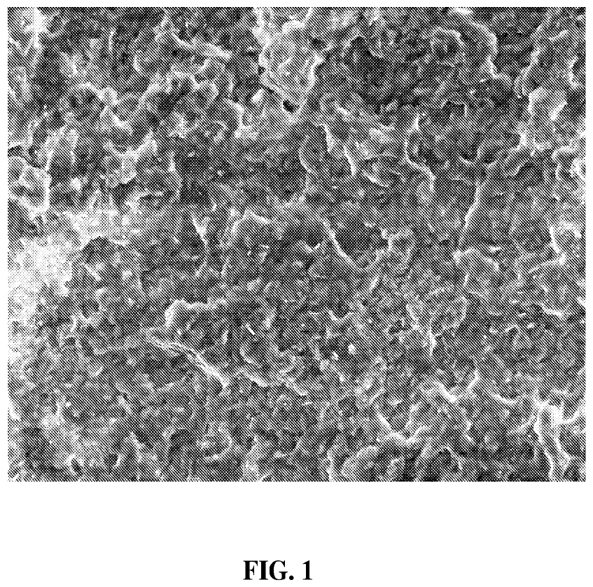

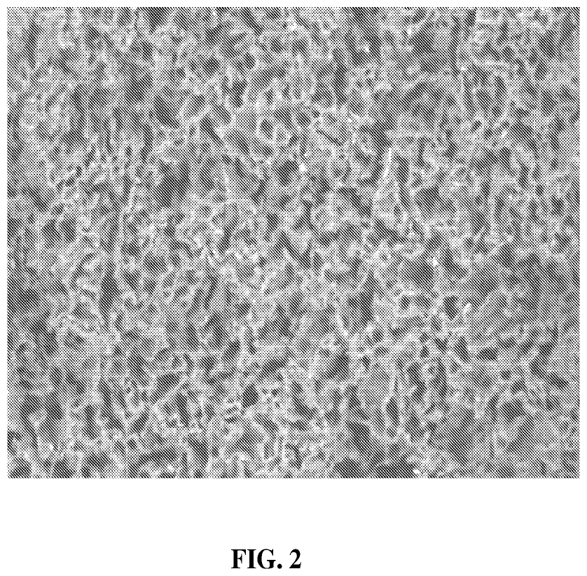

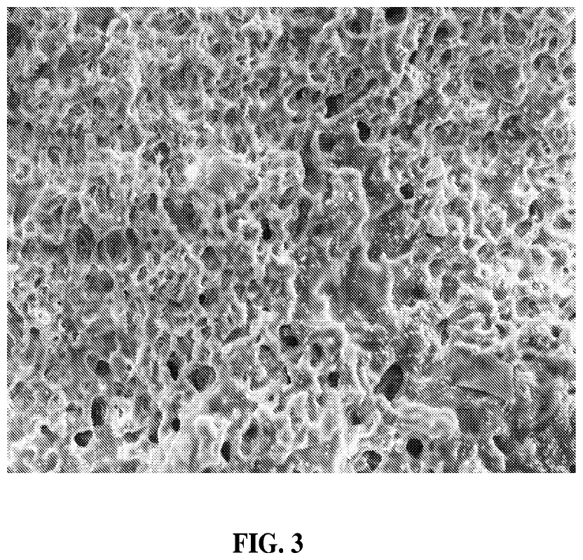

Biodegradation testing was performed on Formulations CE3, 9, and 11 by immersing molded parts in 2 Liters of secondary effluent from the River Falls municipal wastewater treatment facility, and continuously aerated. Samples were submerged in the municipal secondary effluent, at room temperature, continuously aerated, and monitored over a period of two weeks. Samples were weighed prior to placement in the water and removed at 1 week, a secondary set of samples was set up identically and removed after 2 weeks. After the bulk biodegradation testing, samples were dried in an oven at 50° C. for 24 hrs to remove excess moisture and weighed. Biodegradation in the form of mass loss was determined by subtracting the final weight from the initial sample weight and dividing by the initial mass. Samples were also imaged using SEM microscopy to determine the morphology before and after biodegradation. FIGS. 1-3 provide SEM images after 1 week of biodegradation testing for samples Formulation CE3, 9, and 11. Table 6 shows results of this characterization, specifically mass loss after biodegradation.

TABLE 6
BIODEGRADATION RESULTS FOR
FORMULATIONS CE3, 9, and 11

| | | Mass after | Mass after | |
|---|---|---|---|---|
| | Initial | 7 days | 14 days | |
| | Mass | Biodegradation & | Biodegradation & | % Mass |
| Formulation | (g) | Drying (g) | Drying (g) | Loss |
| CE3 | 4.7385 | 7.7450 | | −0.1 |
| 9 | 6.8662 | 5.3601 | | 21.9 |
| 11 | 7.1328 | 3.7883 | | 46.9 |
| CE3 | 4.7505 | | 4.7429 | 0.2 |
| 9 | 6.9884 | | 5.3981 | 22.8 |
| 11 | 7.5253 | | 3.8487 | 48.9 |

Having thus described particular embodiments, those of skill in the art will readily appreciate that the teachings found herein may be applied to yet other embodiments within the scope of the claims hereto attached.

What is claimed is:

1. A biodegradable polymer composition comprising:
a biodegradable polymer; and
a thermally stable sugar;
wherein the biodegradable polymer and the thermally stable sugar are melt processed above their respective melt processing temperatures to form a biodegradable polymer composition.

2. The composition of claim 1, wherein the biodegradable polymer is a biodegradable polyester.

3. The composition of claim 1, wherein the biodegradable polymer is a polylactic acid.

4. The composition of claim 1, wherein the biodegradable polymer is a polyhydroxyalkanoate polymer.

5. The composition of claim 1, wherein the thermally stable sugar is stable at temperatures above 150° C.

6. The composition of claim 1, wherein the thermally stable sugar is stable at temperatures above 170° C.

7. The composition of claim 1, wherein the thermally stable sugar is stable at temperatures above 190° C.

8. The composition of claim 1, wherein the thermally stable sugar is trehalose.

9. The composition of claim 1, wherein the thermally stable sugar is inositol.

10. The composition of claim 1, further comprising one or more additional additives or polymers.

11. The composition of claim 1, wherein the thermally stable sugar has a melting point of at least 186° C.

12. The composition of claim 1, wherein the biodegradable polymer composition forms a feedstock.

13. A three dimensional printed article produced from feedstock of the biodegradable polymer composition of claim 12.

14. An article produced from melt processing the composition of claim 1 using injection molding, extrusion, blow molding, blown film, cast film, vacuum forming or thermoforming melt processing techniques.

15. The article of claim 14 used as packaging, consumer goods, automotive components, electronic components, building and construction components and prototypes.

16. A method comprising:
melt processing a biodegradable polymer and a thermally stable sugar;
wherein the biodegradable polymer and the thermally stable sugar are processed above their respective melt processing temperatures to form a biodegradable polymer composition.
